(19) United States
(12) Patent Application Publication
(10) Pub. No.: US 2023/0283334 A1
(43) Pub. Date: Sep. 7, 2023

(54) WIRELESS RADIO RELAY

(71) Applicant: Mohamed TLICH, El-Alia (TN)

(72) Inventor: Mohamed TLICH, El-Alia (TN)

(21) Appl. No.: 18/002,632

(22) PCT Filed: Jun. 25, 2021
(86) PCT No.: PCT/IB2021/055700

§ 371 Date: Dec. 20, 2022

(30) Foreign Application Priority Data
Jun. 26, 2020 (FR) 2006690

(51) Int. Cl. H04B 7/06; H04L 5/16; H04L 5/00

(52) U.S. Cl. CPC H04B 7/0602; H04L 5/16; H04L 5/0048

(57) ABSTRACT

Radio relay (1) comprising a radiofrequency transceiver (2) integrating a reception channel (RX) and an emission channel (TX), and being configured to allow transmissions according to an operating cycle comprising
a first full-duplex transmission period;
a first half-duplex transmission period during which the reception channel (RX) is configured to allow reception;
a second full-duplex transmission period;
a second half-duplex transmission period during which the emission channel (TX) is configured to allow an emission.

The present invention relates to communication systems used during a measurement campaign, and more particularly to communication means for communicating between devices of a measurement campaign. More specifically, the present invention relates to relay systems and devices for data transfer, in particular during a measurement campaign.

Here, measurement campaign means any activity aimed at observing a physical quantity by means of a plurality of sensors deployed over a wide geographical area, such as a seismic measurement campaign.

In order to be able to carry out a measurement campaign in remote areas without infrastructure networks, embedded telecommunications are an integral part of the measurement campaign systems. To that end, embedded internal communication networks are provided to support most operations in such missions, such as deploying sensors, collecting measurement data, monitoring the proper measurement progress, or communicating between operators in the field.

For example, during a seismic measurement campaign to image the underground geological structure of an area of interest, at least—a first wireless network for commanding Unmanned Aerial Vehicle (also called drones or UAVs) used to drop seismic sensors into the ground (wherein remote controls generally operate in the 433 MHz, 868 MHz, 915 MHz or 2.4 GHz bands);
a second wireless network (of the 4G-LTE type) for transmitting images acquired by cameras embedded on unmanned aerial vehicles;
a third wireless network for collecting seismic data, and optionally
a fourth wireless network (of the LoRaWAN type or walkie-talkies) to support communications between teams in the field;
are used.

However, this multitude of radio networks separated from each other is not without drawbacks.

Indeed, various equipment of these embedded networks (e.g., pylons, base stations, power supplies) involve significant costs in a number of ways, in particular: acquisition, logistics to make them reach measurement environments that are often difficult to access, installation/uninstallation, or maintenance because of their frequent movement or their use in sometimes extreme conditions (prospecting in dense and humid forests for example).

Multiplying such equipment is, moreover, inevitable to cover an extensive or uneven area. For example, the range of the command signals of aerial vehicles or the communication signals between the teams in the field is, in general, far less than the dimensions of the probed field so that equipment redundancy is required.

In addition, a configuration specific to each network according to the measurement environment must be implemented. The successful completion of the measurement campaign depends on the proper functioning of each of these embedded radio networks.

Another drawback is the environmental impact caused by the simultaneous use of several radio networks and the “radio pollution” that can result therefrom.

An object of the present invention is to remedy the aforementioned drawbacks.

To that end, a radio relay is firstly proposed, comprising a radiofrequency transceiver integrating a reception channel and an emission channel, this radiofrequency transceiver being configured to allow transmissions according to an operating cycle comprising
a first full-duplex transmission period during which the reception channel and the emission channel are configured to allow, respectively, a reception according to a first radio transmission mode and an emission according to a second radio transmission mode different from the first radio transmission mode;
a first half-duplex transmission period during which the reception channel is configured to allow a reception according to at least a third radio transmission mode;
a second full-duplex transmission period during which the reception channel and the emission channel are configured to allow, respectively, a reception according to the second radio transmission mode and an emission according to the first radio transmission mode;
a second half-duplex transmission period during which the emission channel is configured to allow an emission according to at least the third radio transmission mode.

Various additional features may be provided, alone or in combination:
the radio relay further comprises an antenna device, this antenna device having a radiation pattern comprising a first lobe in a first emission/reception direction, a second lobe in a second emission/reception direction, a third lobe in a third emission/reception direction, the second and the third emission/reception direction being substantially included in a plane, the first emission/reception direction being substantially perpendicular to said plane;
the radio frequency transceiver is configured to allow, during the first half-duplex transmission period, a reception in the first emission/reception direction, the RF transceiver being further configured to allow, during the second half-duplex transmission period, an emission in the first emission/reception direction;
the radio frequency transceiver is configured to allow emission in the first emission/reception direction during the first full-duplex transmission period, and reception in the first emission/reception direction during the second full-duplex transmission period;
the radiofrequency transceiver is configured to allow during the first full-duplex transmission period, an emission in the first emission/reception direction, and a reception in the second emission/reception direction, and during the second full-duplex transmission period, a reception in the first emission/reception direction, and an emission in the second emission/reception direction;
the third radio transmission mode is the first radio transmission mode;
the second radio transmission mode or the third radio transmission mode is associated with a predefined area, this second radio transmission mode or this third radio transmission mode being assigned to the radio relay when this radio relay is located in said predefined area;
the first radio transmission mode and the second radio transmission mode use, respectively, a first frequency and a second frequency different from the first frequency, and/or a first modulation and a second modulation based on orthogonal codes, and/or a first antenna polarization and a second antenna polarization different from the first antenna polarization; and/or a first emission/reception direction and a second emission/reception direction different from the first emission/reception direction.

Secondly, a data transfer system is proposed, comprising
a first radio relay and a second radio relay, wherein the first radio relay and the second radio relay are configured to operate, respectively, during the first half-duplex transmission period and the first full-duplex transmission period in a simultaneous manner, the first radio relay and the second radio relay being further configured to operate, respectively, during the second half-duplex transmission period and the second full-duplex transmission period in a simultaneous manner, or
a first radio relay and a second relay, the first radio relay being configured to operate during the first half-duplex transmission period when the second radio relay is configured to operate during the second half-duplex transmission period, the first radio relay being further configured to operate during the second half-duplex transmission period when the second radio relay is configured to operate during the first half-duplex transmission period.

This system further comprises an aerial vehicle, wherein this aerial vehicle is provided with the second radio relay.

Other features and advantages of the invention will appear more clearly and concretely upon reading the following description of embodiments, which is written with reference to the appended drawings in which:

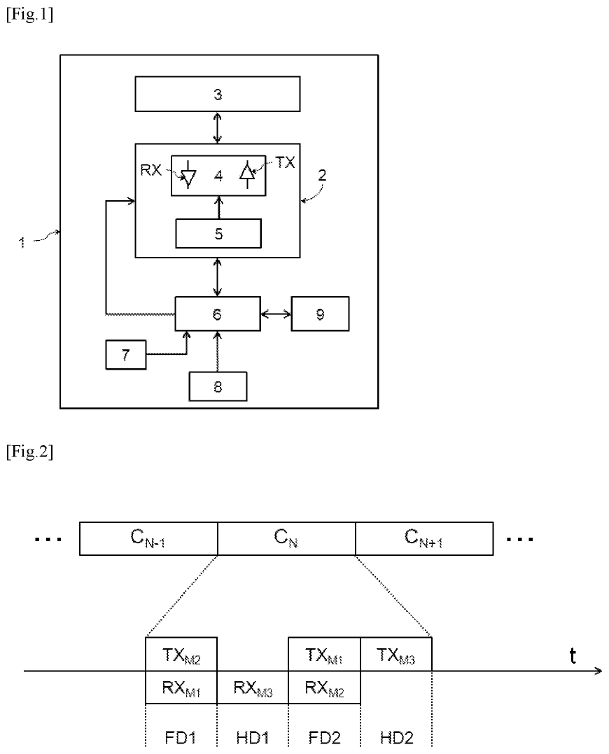

The FIG. 1 schematically illustrates a radio relay according to various embodiments;

The FIG. 2 schematically illustrates an operating cycle according to various embodiments of the radio relay;

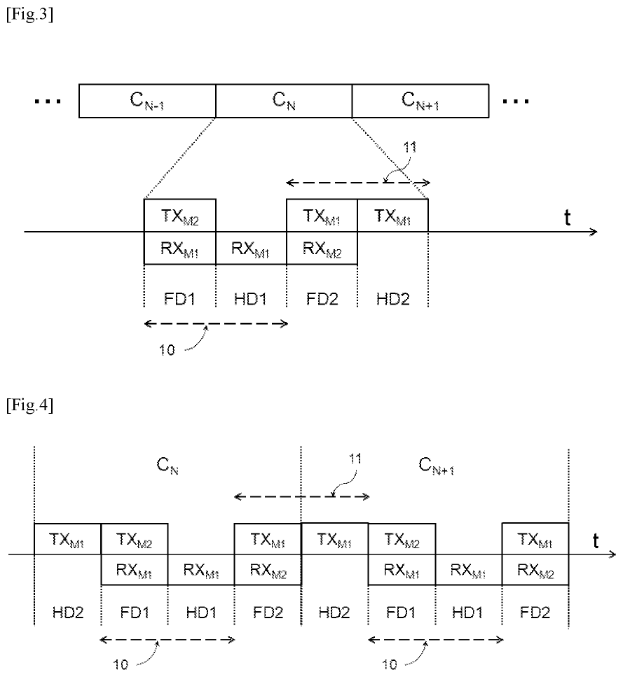

The FIG. 3 schematically illustrates another operating cycle according to various embodiments of the radio relay;

The FIG. 4 schematically illustrates another operating cycle according to various embodiments of the radio relay;

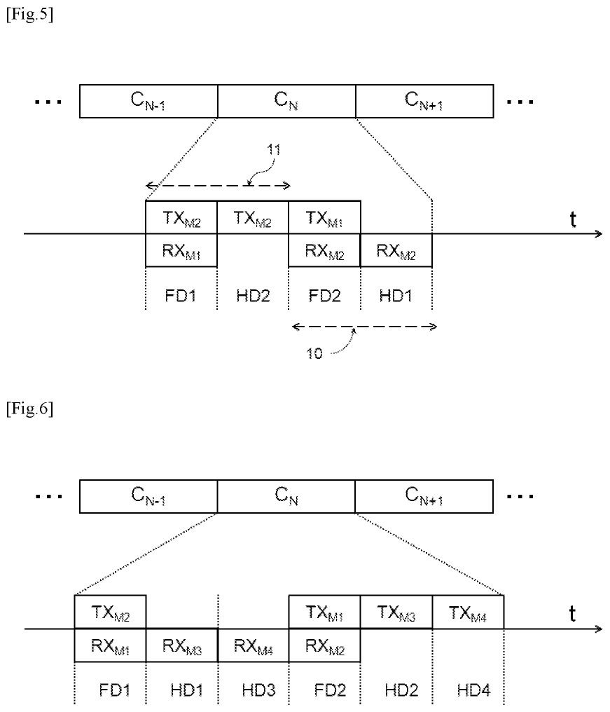

The FIG. 5 schematically illustrates another operating cycle according to various embodiments of the radio relay;

The FIG. 6 schematically illustrates another operating cycle according to various embodiments of the radio relay;

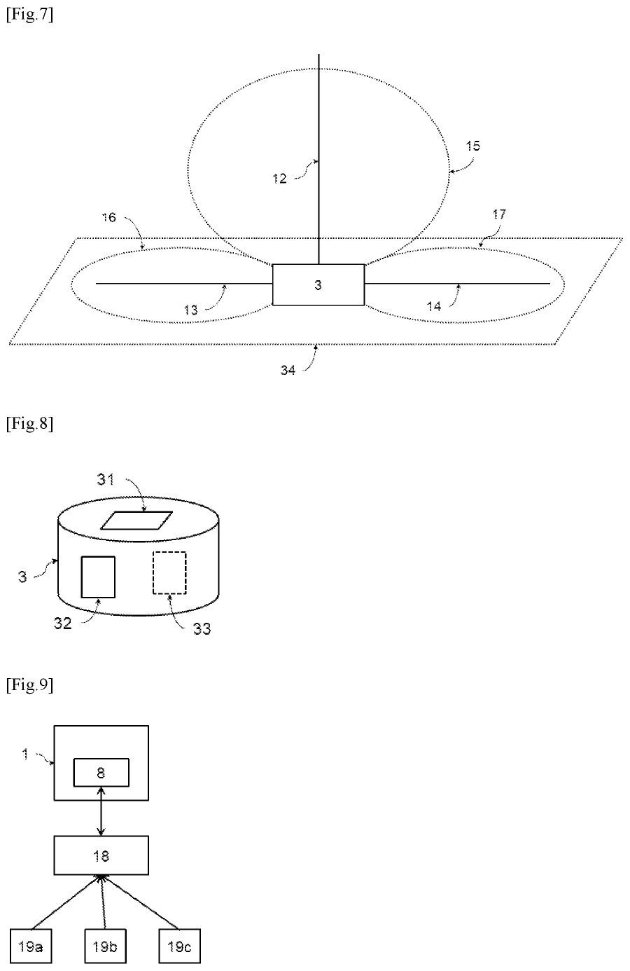

The FIG. 7 schematically illustrates an antenna device of the radio relay according to various embodiments;

The FIG. 8 schematically illustrates another antenna device of the radio relay according to various embodiments;

The FIG. 9 schematically illustrates a first use of the radio relay according to various embodiments;

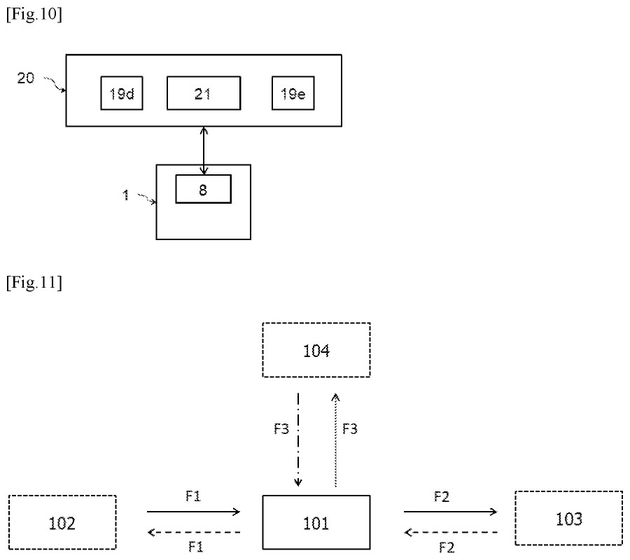

The FIG. 10 schematically illustrates a second use of the radio relay according to various embodiments;

The FIG. 11 schematically illustrates the use of the radio relay with other radio relays;

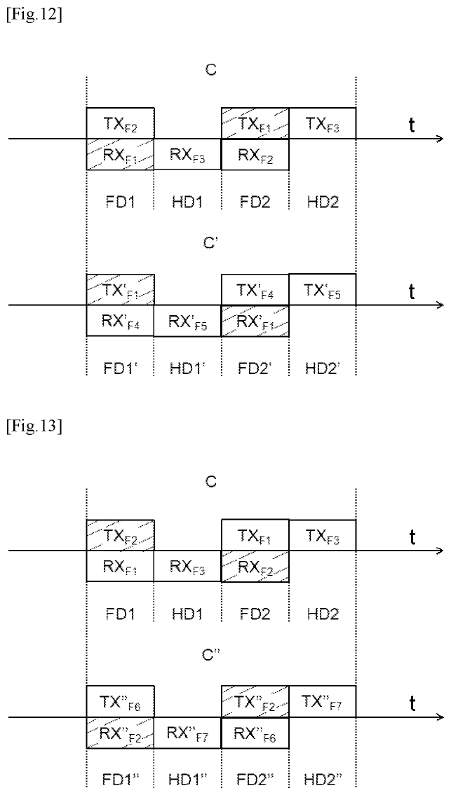

The FIG. 12 schematically illustrates two operating cycles implemented by two radio relays to transfer data;

The FIG. 13 schematically illustrates two operating cycles implemented by two radio relays to transfer data according to various embodiments;

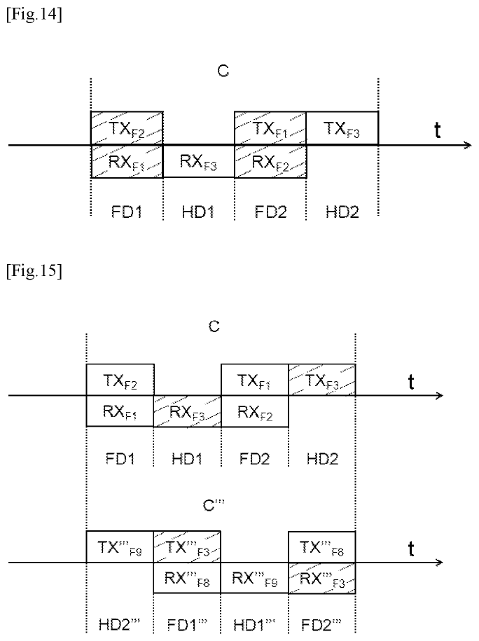

The FIG. 14 schematically illustrates an operating cycle implemented by a radio relay to transfer data according to various embodiments;

The FIG. 15 schematically illustrates two operating cycles implemented by two radio relays according to various embodiments;

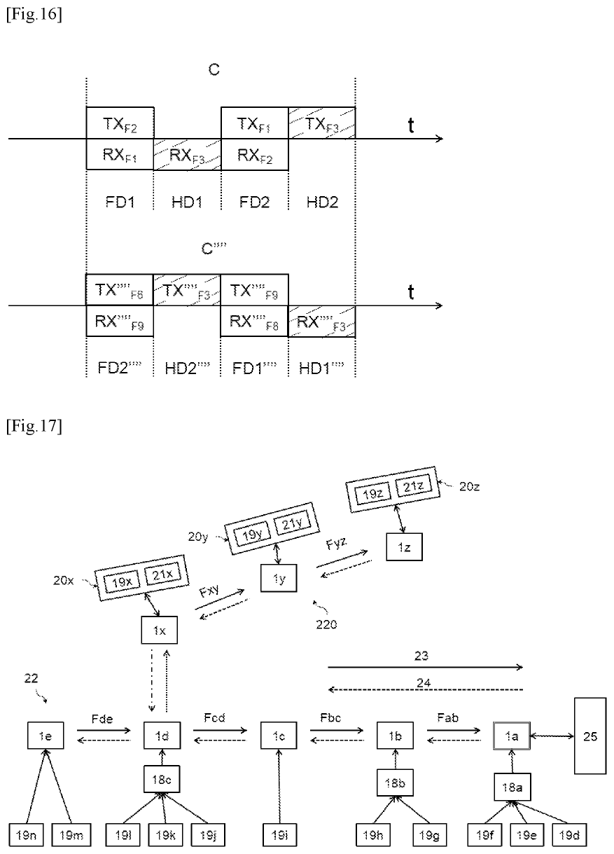

The FIG. 16 schematically illustrates two operating cycles implemented by two radio relays;

The FIG. 17 schematically illustrates a junction between two radio relay lines according to various embodiments;

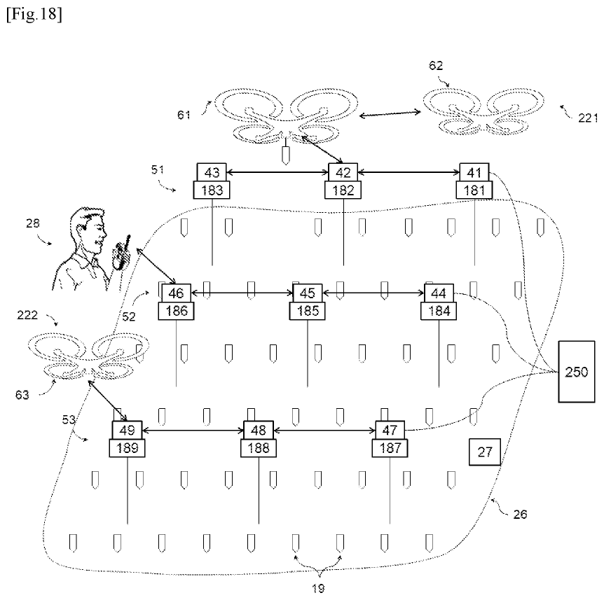

FIG. 18 schematically illustrates the use of the radio relay in a measurement campaign.

Referring to FIG. 1, a wireless radio relay 1 capable of operating full-duplex (in French “duplex integral”) is displayed. This radio relay 1 comprises a radio frequency (RF) emitter-receiver 2 (or “RF transceiver”) and an antenna device 3.

The RF transceiver 2 includes a baseband circuit 5. This baseband circuit 5 groups together electronic circuits for processing the baseband signal such as an analog/digital converter, a digital/analog converter, or a baseband filter. The RF transceiver 2 further comprises an RF front-end circuit 4 (also called RF head, radio stage or “RF front-end”) connected to the antenna device 3. The RF front-end circuit 4 groups together the electronic circuits (filters, mixers, amplifiers, oscillator, modulator/demodulator, frequency synthesizer, and/or switches, for example) located between the antenna device 3 and the baseband circuit 5. Instead of an RF transceiver 2, a dedicated RF emitter and RF receiver can, of course, be contemplated.

The RF front-end circuit 4 comprises an analog emission channel (or line) TX for processing the analog signals before they are transmitted through the air via the antenna device 3, and an analog reception channel (or line) RX for the processing of the analog signals received through the antenna device 3. By operating full-duplex, the RF front-end circuit 4 is capable of simultaneously receiving on the reception channel RX and emitting on the emission channel TX.

The antenna device 3 includes one or more antennas. When the radio relay 1 is provided with a plurality of antennas, the RF front-end circuit 4 comprises a switch making it possible to connect the reception channel RX and the emission channel TX to one or several antennas of the antenna device 3.

The radio relay 1 comprises a processing unit 6 configured to supply the RF transceiver 2 with the data to be emitted, as well as to process the data received from this RF transceiver 2. The processing unit 6 additionally makes it possible to configure the RF transceiver 2. Herein, processing unit 6 means any device (in particular, an electronic card) integrating a processor or, more generally, integrated circuits (e.g., ASIC, FPGA) programmed to provide, in a dedicated or shared manner, one or more predetermined functions.

The configuration of the RF transceiver 2 aims to allow reception and/or emission according to predefined radio transmission modes at precise time intervals. This configuration includes the definition of a plurality of operating parameters of the RF transceiver 2. These parameters integrate, inter alia, the emission frequency, the reception frequency, the emission and/or reception bandwidth (e.g., 5 MHz, 10 MHz, 20 MHz, 40 MHz or 80 MHz). The emission and/or reception frequencies are preferably included in ISM (industrial, scientific and medical) frequency bands such as the 2.4-GHz or 5-GHz bands or, in general, in frequency bands available in most parts of the world. The emission and/or reception bandwidths are, in an embodiment, selected so as to be capable of conveying high-speed data (from 2 to several tens of Mbps, for example).

In another embodiment, the RF transceiver 2 is of the narrow band type (for low-speed wireless communications, for example, from a few bits per second to 2 Mbps). To that end, frequencies of 433 MHz, 868 MHz, or 915 MHz with narrow bandwidths (of a few tens of KHz) can be adopted. Such an RF transceiver 2 can be used, for example, to convey command and/or control messages.

The configuration parameters of the RF transceiver 2 can also comprise the selection of a modulation based on orthogonal (or pseudo-orthogonal) codes, of a demodulation based on orthogonal (or pseudo-orthogonal) codes, of an emission or reception antenna polarization, an emission frequency, a reception frequency, one or more emission and/or reception antennas, an emission power, and/or an operating state (e.g., activation/deactivation, standby, or hibernation) of the reception channel RX and/or of the emission channel TX.

The processing unit 6 is provided with a time reference 7 serving as a time base, among other things, for the configuration of the RF transceiver 2. This time reference 7 comprises an internal clock of the radio relay 1 or reception means for receiving an external signal used as a time base. In an embodiment, the time reference 7 is provided by a receiver of a global radiolocation signal (of the GPS, GLONASS, GALILEO, or BeiDou type). The time base used by the processing unit 6 is, in a preferred embodiment, a signal comprising time information such as the PPS (Pulse Per Second) signal supplied by a GPS receiver. In addition to its use as a time reference, a global radiolocation signal advantageously makes it possible to locate the radio relay 1. As a variant or in combination, the time base used by the processing unit 6 is a clock synchronized by a time synchronization mechanism within a wireless network integrating the radio relay 1.

Furthermore, the radio relay 1 includes at least one digital interface 8. This digital interface 8 is any wired or wireless input/output module for receiving digital data, according to any protocol such as UART, SPI, I2C, USB, Ethernet, PCI, PCI-X, PCI-E, Bluetooth, Wi-Fi, Lora, or Zigbee.

The radio relay 1 is provided with at least one memory 9 intended to store at least temporarily therein, through the processing unit 6, data received via the reception channel RX and/or the digital interface 8. This memory 9 is any medium (volatile or non-volatile) for computer-readable data, such as flash memories, hard drives, or a random-access memory (RAM). In an embodiment, configuration data of the RF transceiver 2, and/or information relating to the radio relay 1 (e.g., identifier or position data), and/or measurement data (such as seismic data) are also stored in the memory 9.

Electrical energy supply means (not shown) are intended to supply the radio relay 1 electronic circuits. In an embodiment, this electrical energy supply means comprises an electrical, in particular electrochemical, energy storage means, such as cells, batteries or more generally electrochemical accumulators. In another embodiment, the electrical energy supply means further comprises an electrical energy generator such as a photovoltaic generator whose generated electrical energy is at least partly stored into the electrical energy storage means. Alternatively or in combination, the electrical energy supply means comprises an electrical supply and/or charging port. This port is, in an embodiment, integrated to the digital interface 8 (a USB port, for example).

Referring to FIG. 2, the RF transceiver 2 is configured to operate cyclically. In other words, this RF transceiver 2 is configured to allow transmissions (i.e., emissions-receptions) according to an operating cycle C. Once configured, this operating cycle C is reiterated by the RF transceiver 2 through the successive time cycles C_{N-1}, C_{N}, C_{N+1} as illustrated by FIG. 2. The transmissions supported or permitted by the RF transceiver 2 thus have a periodical nature over time. The time axis t of the time reference 7 is, in fact, divided into successive time cycles C_{N-1}, C_{N}, C_{N+1} having the same predefined time duration. This duration is, for example, 10 ms, 50 ms, 100 ms, or 250 ms.

An operating cycle C of the RF transceiver 2 comprises a plurality of distinct periods each spreading over a predefined duration. In an embodiment, this operating cycle C of the RF transceiver 2 comprises
a first full-duplex transmission period FD1 during which the reception channel RX and the emission channel TX are configured to allow, respectively, a reception according to a first radio transmission mode M1 (designated by RX_{M1} in FIG. 2) and an emission according to a second radio transmission mode M2 different from the first radio transmission mode M1 (designated by TX_{M2} in FIG. 2);
a first half-duplex transmission period HD1 (i.e., alternately or “half-duplex”) during which the reception channel RX is configured to allow a reception according to at least a third radio transmission mode M3 (designated by RX_{M3} on FIG. 2);
a second full-duplex transmission period FD2 during which the reception channel RX and the emission channel TX are configured to allow, respectively, a reception according to a second radio transmission mode M2 (designated by RX_{M2} in FIG. 2) and an emission according to the first radio transmission mode M1 (designated by TX_{M1} in FIG. 2);
a second half-duplex transmission period HD2 during which the emission channel TX is configured to allow an emission according to at least the third radio transmission mode M3 (designated by TX_{M3} in FIG. 2).

The periods FD1, FD2, HD1, HD2 are distinct time windows of the operating cycle C during which an emission and/or a reception according to the radio transmission modes M1, M2, M3 can be carried out by the radio relay 1 by means of the RF transceiver 2. The temporal layout displayed in FIG. 2 of these periods FD1, HD1, FD2, HD2 is only given by way of example and in no way limitative. The order of these periods FD1, FD2, HD1, HD2 within the operating cycle C is part of the configuration parameters of the RF transceiver 2. In other words, by changing the arrangement in time of the periods FD1, FD2, HD1, HD2, the configuration of the RF transceiver 2 is changed. In the embodiment illustrated in FIG. 2, the first and the second full-duplex transmission periods FD1, FD2 are interleaved (or alternated) with the first and the second half-duplex transmission periods HD1, HD2.

The RF transceiver 2 is configured to allow simultaneous use of the emission channel TX and the reception channel RX during the first and the second full-duplex transmission periods FD1, FD2. On the other hand, only the reception channel RX or the emission channel TX can be used during the first and the second half-duplex transmission period HD1, HD2.

During the first half-duplex transmission period HD1, the emission channel TX is inactive, i.e., standby, shutdown (deactivated), free, or simply not used (no signal being emitted on this emission channel TX). Similarly, the reception channel RX is, during the second half-duplex transmission period HD2, inactive, i.e., in standby, shutdown (deactivated), free, or simply not used (no signal being processed by this reception channel RX).

By exploiting the operating cycle C of the RF transceiver 2 (i.e., by operating during the one or the other periods of this operating cycle C), the radio relay 1 is capable of
simultaneously receiving and emitting (i.e., operating full-duplex), respectively, according to a first radio transmission mode M1 and a second radio transmission mode M2 (for example, a first frequency and a second frequency different from the first frequency) during the first full-duplex transmission period FD1;
simultaneously receiving and emitting (i.e., operating full-duplex), respectively, according to the second radio transmission mode M2 and the first radio transmission mode M1 (for example, the second frequency and the first frequency) during the second full-duplex transmission period FD2;
receiving only according to at least a third radio transmission mode M3 (for example, a third frequency) during the first half-duplex transmission period HD1; and
emitting only according to at least the third radio transmission mode M3 during the second half-duplex transmission period HD2.

The duration of the operating cycle C and/or of its periods FD1, FD2, HD1, HD2 is expressed as a function of the time reference 7. The periods FD1, FD2, HD1, HD2 can have different or equal durations. The duration of each of the periods FD1, FD2, HD1, HD2 can be adapted according to the nature (e.g., video data, measurement data, or control data of the acknowledgment or request type) and/or the quantity of data to be received and/or to send during this period FD1, FD2, HD1, HD2. For example, the first or the second full-duplex transmission period FD1, FD2 can have a duration greater than the duration of the first or the second half-duplex transmission period HD1, HD2. In another embodiment, the duration of the first full-duplex transmission period FD1 is greater than the duration of the second full-duplex transmission period FD2. In another embodiment, the duration of the first half-duplex transmission period HD1 is greater than the duration of the second half-duplex transmission period HD2.

Moreover, the periods FD1, FD2, HD1, HD2 of the operating cycle C can be spaced out from each other (i.e., separated) or contiguous.

Advantageously, the use during the first and the second full-duplex transmission period FD1, FD2 of two different radio transmission modes M1, M2 makes it possible to avoid or at least to reduce interference due to simultaneous reception and emission (self-interference). The first and the second radio transmission modes M1, M2 can use different frequencies, and/or different antenna polarizations (e.g., horizontal, vertical, right circular polarization, left circular polarization, oblique polarization at +45 degrees, or oblique polarization at −45 degrees), and/or modulations based on orthogonal (or pseudo-orthogonal) codes, and/or different emission/reception directions. For instance,
during the first full-duplex transmission period FD1, the reception channel RX is configured to allow reception on a first frequency (and/or a first antenna polarization, and/or a first modulation with orthogonal codes, and/or a first emission/reception direction) while the emission channel TX is configured to allow emission on a second frequency (and/or a second antenna polarization, and/or a second modulation with orthogonal codes, and/or a second emission/reception direction) different from the first frequency (and/or from the first antenna polarization and/or from the first orthogonal code modulation, and/or from the first emission/reception direction);
during the second full-duplex transmission period FD2, the reception channel RX is configured to allow reception on the second frequency (and/or the second antenna polarization, and/or the second modulation with orthogonal codes, and/or the first emission/reception direction) while the emission channel TX is configured to allow emission on the first frequency (and/or the first antenna polarization, and/or the first modulation with orthogonal codes and/or the first emission/reception direction).

An emission/reception direction of a radio transmission mode M1, M2 can be defined by a physical orientation of an antenna or antennas of the antenna device 3 to which the emission channel TX or reception channel RX is connected, and/or by spatial filtering signal processing (better known as “beamforming”) using a plurality of antennas of the antenna device 3 to which the emission channel TX or reception channel RX is connected.

In an embodiment, the third radio transmission mode M3 shares with the first radio transmission mode M1 or the second radio transmission mode M2 at least one radio transmission parameter. This radio transmission parameter is, for example, a frequency, an antenna polarization, one or several antennas of the antenna device 3, an orthogonal code modulation, an emission/reception direction.

The first and the second full-duplex transmission periods FD1, FD2 and the first and the second half-duplex transmission periods HD1, HD2 occur at distinct time intervals (a time-division multiplexing) so that an at least partial reuse of the first or the second radio transmission mode M1, M2 during the first and the second half-duplex transmission periods HD1, HD2 is without interference risk. Such an at least partial reuse (in particular of the frequency and/or of the antenna polarization) advantageously makes it possible to use fewer radio transmission modes which are generally limited, as well as to reduce the switching number between the radio transmission modes of the reception channel RX and the emission channel TX.

In an embodiment, the third radio transmission mode M3 is chosen equal to the first or second radio transmission mode M1, M2. When the third radio transmission mode M3 is the first radio transmission mode M1 (in other words, the third radio transmission mode M3 is none other than the first radio transmission mode M1), particular arrangements in time of the periods FD1, FD2, HD1, HD2 make it possible, advantageously, to reduce the number of switching operations of the radio transmission modes M1, M2 of the reception channel RX and of the emission channel TX.

In an embodiment, the first full-duplex transmission period FD1 and the first half-duplex transmission period HD1 are successive in a same iteration C_{N} of the operating cycle C (as shown in FIG. 3) or in two successive iterations C_{N}, C_{N+1} of the operating cycle C so that the configuration of the reception channel RX to allow a reception according to a same radio transmission mode M1 can be (at least partially) preserved during these two successive periods FD1, HD1 (illustrated by the extent 10).

The second full-duplex transmission period FD2 and the second half-duplex transmission period HD2 are successive in a same iteration C_{N} of the operating cycle C (as shown in FIG. 3), or in two successive iterations C_{N}, C_{N+1} of the operating cycle C (as shown in FIG. 4) so that the configuration of the emission channel TX to allow an emission according to a same radio transmission mode M1 can be (at least partially) preserved during these two successive periods FD2, HD2 (illustrated by the extent 11).

More generally, the first full-duplex transmission period FD1 and the first half-duplex transmission period HD1 (respectively, the second full-duplex transmission period FD2 and the second half-duplex transmission period HD2) are successive in the operating cycle C or are, respectively, at the beginning and at the end of the operating cycle C. When the operating cycle C begins with the first full-duplex period transmission FD1 and ends with the first half-duplex transmission period HD1, these two periods FD1, HD1 occur in a successive manner by reiterating the operating cycle C of the RF transceiver 2.

In the example of FIG. 3, in order to reduce the number of frequency switching operations, the RF transceiver 2 is configured to allow an emission (respectively, a reception) on the same frequency during the second full-duplex transmission period FD2 (respectively, the first period FD1) and the second half-duplex transmission period HD2 (respectively, the first period HD1). A switching between the frequencies can, indeed, generate additional waiting times before proceeding to sending or receiving data, until the frequency synthesis (PLL) in the front-end RF circuit 4 stabilizes. Consequently, the periods FD1, FD2, HD1, HD2 are, in an embodiment, arranged within the operating cycle C so as to reduce the number of frequency switching operations. In the example of FIG. 3, a frequency change occurs every second period, namely between the half-duplex transmission period HD1 and the full-duplex transmission period FD2 (the reception changes from the first frequency to the second frequency and, conversely, the emission switches from the second frequency to the first frequency), and at the end of the operating cycle C. At these instants, the RF transceiver 2 (or, more precisely, the RF front-end circuit 4) switches the frequencies of its analog emission channel TX and its reception channel RX.

FIG. 5 illustrates the case where the third radio transmission mode M3 is identical to the second radio transmission mode M2. It should be noted that, compared to the example of FIG. 3, the first and the second half-duplex transmission period HD1, HD2 are alternated. When an emission TX_{M1} (respectively, RX_{M1}) is provided in the operating cycle C illustrated in FIG. 3, a reception RX_{M2} (respectively, TX_{M2}) is provided in the operating cycle C illustrated in FIG. 5.

FIG. 5 also illustrates an arrangement in time of the periods FD1, FD2, HD1, HD2 different from that of FIG. 3.

In an embodiment illustrated in FIG. 6, the operating cycle C of the RF transceiver 2 comprises an additional pair of half-duplex transmission periods HD3, HD4. In addition to the periods FD1, FD2, HD1, HD2 described above, this operating cycle C of the RF transceiver 2 comprises
a third half-duplex transmission period HD3 during which the reception channel RX is configured to allow reception according to at least a fourth radio transmission mode M4 (designated by RX_{M4} in FIG. 6);
a fourth half-duplex transmission period HD4 during which the emission channel TX is configured to allow emission according to at least the fourth radio transmission mode M4 (designated by TX_{M4} in FIG. 6).

In order to reduce, in the example operating cycle C illustrated in FIG. 6, the number of switching operations between the radio transmission modes of the reception channel RX and of the emission channel TX, the fourth radio transmission mode M4 can be chosen equal to, or more generally share at least one radio transmission parameter with, the second or the third radio transmission mode M2, M3.

The antenna device 3 comprises, in an embodiment, at least one antenna having a substantially omnidirectional (i.e., spherical) or hemispherical (half of a sphere) radiation pattern. The reception channel RX and/or the emission channel TX is/are, in this embodiment, connected during the periods FD1, FD2, HD1, HD2 to this omnidirectional antenna.

In another embodiment, the antenna device 3 comprises at least a first antenna and a second antenna that are substantially identical, forming together a substantially hemispherical radiation pattern (two quarters of a sphere). The reception channel RX is connected during the periods FD1 and FD2 to, respectively, said first antenna and said second antenna and during the period HD1 to said first antenna or to said second antenna. The emission channel RX is connected during the periods FD1 and FD2 to, respectively, said second antenna and said first antenna and during the period HD2 to said first antenna or to said second antenna.

The antenna device 3 has, in another embodiment illustrated by FIG. 7, a radiation pattern comprising
a first lobe 15 in a first emission/reception direction 12;
a second lobe 16 in a second emission/reception direction 13;
at least one third lobe 17 in a third emission/reception direction 14, this third emission/reception direction 14 and the second emission/reception direction 13 being substantially included in a plane 34.

The first emission/reception direction 12 is substantially perpendicular to the plane 34 or inclined (oblique) with respect to the plane 34. For example, the first emission/reception direction 12 is substantially vertical, whereas the second and third emission/reception directions 13, 14 are substantially horizontal. In another embodiment, the second emission/reception direction 13 and the third emission/reception direction 14 are two opposing directions.

The opening angle of the first lobe 15 is, for example, 60, 90, 120, or 150 degrees. The opening angle of the second and/or third lobe 16, 17 is, for example, 30, 60, 90, or 120 degrees.

In and embodiment, the antenna device 3 allows (by having an omnidirectional, hemispherical radiation pattern, or a combination of lobes) the radio relay 1 to emit and receive in at least two substantially horizontal directions and in at least one substantially vertical or inclined direction with respect to a substantially horizontal plane.

In FIG. 8, an antenna device 3 of the radio relay 1 is displayed. This antenna device 3 includes
a first antenna 31 having a radiation pattern which includes at least the first lobe 15;
a second antenna 32 having a radiation pattern which includes at least the second lobe 16;
a third antenna 33 having a radiation pattern which includes at least the third lobe 17.

The RF transceiver 2 is, in an embodiment, configured to allow, during the first half-duplex transmission period HD1, a reception in the first emission/reception direction 12. The RF transceiver 2 is furthermore configured to allow, during the second half-duplex transmission period HD2, an emission in the first emission/reception direction 12. In this regard, the emission channel RX and the emission channel TX are, in an embodiment, configured to be connected, respectively, during the first half-duplex transmission period HD1 and the second half-duplex transmission period HD2, to the first antenna 31. This configuration allows a radio relay 1 to communicate during its first and its second half-duplex transmission periods HD1, HD2 with another radio relay located substantially in the first emission/reception direction 12 (e.g., a land radio relay and an aerial radio relay as described below).

In another embodiment, the RF transceiver 2 is configured to allow emission in the first emission/reception direction 12 during the first full-duplex transmission period FD1, and reception in the first emission/reception direction 12 during the second full-duplex transmission period FD2. To that end, the reception channel RX and the emission channel TX are configured to be connected, respectively, during the second full-duplex transmission period FD2 and during the first full-duplex transmission period FD1, to the first antenna 31. This configuration allows a radio relay 1 to communicate during its first and its second full-duplex transmission periods FD1, FD2 with another radio relay located substantially in the first emission/reception direction 12 (e.g., an aerial radio relay and a land radio relay as described below).

In another embodiment, the RF transceiver 2 is configured to allow
during the first full-duplex transmission period FD1, an emission in the first emission/reception direction 12, and a reception in the second emission/reception direction 13;
during the second full-duplex transmission period FD2, a reception in the first emission/reception direction 12, and an emission in the second emission/reception direction 13.
   To that end, the reception channel RX and the emission channel TX are configured to be connected
during the first full-duplex transmission period FD1, respectively, to the second antenna 32 and to the first antenna 31, and
during the second full-duplex transmission period FD2, respectively, to the first antenna 31 and to the second antenna 32. This configuration allows a radio relay 1, during its first full-duplex transmission period FD1 (respectively, its second full-duplex transmission period FD2), to receive from a radio relay located substantially in the second emission/reception direction 13 (respectively, in the first emission/reception direction 12) and to emit to a radio relay located substantially in the first emission/reception direction 12 (respectively, in the second emission/reception direction 13). It follows that a radio relay 1 is capable, during each of the first and second full-duplex transmission period FD1, FD2 of emitting and receiving in two substantially perpendicular directions (for example, an aerial radio relay connected on the one hand to a land radio relay and on the other hand to another aerial radio relay, the two aerial radio relays being substantially at the same height).

In another embodiment, the reception channel RX and the emission channel TX are configured to be connected during the first full-duplex transmission period FD1, respectively to the second antenna 32 and to the third antenna 33, and during the second full-duplex transmission period FD2, respectively, to the third antenna 33 and to the second antenna 32.

In an embodiment, an operating cycle C of the RF transceiver 2 is defined by an instruction program loaded or programmed in the processing unit 6. The parameters of an operating cycle C include its duration, the number of periods, the order of the periods FD1, FD2, HD1, HD2, the duration of each period FD1, FD2, HD1, HD2, the radio transmission modes M1, M2, M3 (frequency, bandwidth, antenna polarization, modulation with orthogonal codes, or emission or reception direction, e.g.). These parameters can also include an indication of one or more antennas of the antenna device 3 to which the emission channel TX and the reception channel RX are connected during each of the periods FD1, FD2, HD1, HD2, or the transmission power when the emission channel TX is active. The processing unit 6 thus configures the RF transceiver 2 based on the parameters of an operating cycle C loaded into the memory 9.

The radio relay 1 is, in an embodiment illustrated by FIG. 9, connected via its digital interface 8 to a gateway 18 or, more generally, to a data source. This gateway 18 is configured to receive measurement data supplied by sensors 19a-19c to which this gateway 18 is connected. Here, sensor means any device capable of transforming the state of an observed physical quantity into digital data such as an image sensor, a sound sensor, a seismic sensor, a position sensor, a temperature sensor, or a CO₂ sensor. Alternatively, the radio relay 1 is directly connected via its digital interface 8 to the sensors 19a-19c (i.e., without the gateway 18).

In another embodiment, the radio relay 1 is integrated in a vehicle 20, in particular an aerial vehicle without a crew on board (a drone) (the radio relay 1 is therefore called an aerial radio relay). This aerial vehicle 20 comprises a control unit 21 making it possible to control the piloting of the aerial vehicle 20 and one or more sensors 19d-19e such as a camera or, more generally, an image sensor, a sound sensor, or a position sensor (FIG. 10).

The data that the radio relay 1 can transfer via the emission channel TX during an operating cycle C of the RF transceiver 2, can include
data received by the digital interface 8;
data received by the reception channel RX;
data stored in the memory 9 such as data previously received by the digital interface 8 or by the reception channel RX or any other data concerning the radio relay 1 (for example, an identifier of the radio relay 1, position data of the radio relay 1, the charge level of a battery in use by the radio relay 1, the performance or the operating state of one or several modules of the radio relay 1, the parameters of the operating cycle C when being executed, the rank of the current iteration of the operating cycle C or, more generally, any data available to the processing unit6);
synchronization frames;
data generated by the processing unit 6 from data received by the reception channel RX and/or by the digital interface 8 such as an acknowledgment following the reception of data, a quality control message, a data size (a number of bytes), data received to which processing is applied (filtering, compression, statistical calculation applied to digital data, e.g.).

FIG. 11 illustrates the operation of a first radio relay 101 whose RF transceiver 2 is configured to allow emissions-receptions according to a predefined operating cycle C. The latter is, by way of illustrative example, the four-period operating cycle C of FIG. 2. The periods FD1, FD2, HD1, HD2 of this operating cycle C are arranged in time in this order: the first full-duplex transmission period FD1, the first half-duplex transmission period HD1, the second full-duplex transmission period FD2, and the second half-duplex transmission period HD2. Without this being limiting, the radio transmission modes M1, M2, M3 are, in this example, the frequencies F1, F2 and F3.

The first radio relay 101 and a second radio relay 102 are within range of each other, and share the same time reference. The second radio relay 102 comprises an RF transceiver configured to allow transmissions according to an operating cycle C′ integrating, like the operating cycle C of the first radio relay 101, a first and a second full-duplex transmission period FD1′, FD2′ and a first and a second half-duplex transmission period HD1′, HD2′.

The first radio relay 101 and the second radio relay 102 are configured to operate, respectively, during the first and the second period FD1, FD2 and the first and the second period FD1′, FD2′ in a synchronous (or simultaneous) manner, as illustrated in FIG. 12. The radio transmission modes M1′, M2′, M3′ relating to the operating cycle C′ of the second radio relay 102 are three frequencies F4, F1, F5. In particular, the second radio transmission mode M2′ of the second radio relay 102 is the same as the first radio transmission mode M1 of the first radio relay 101 (namely, frequency F1).

As shown in FIGS. 11 and 12, the first radio relay 101 is therefore capable of
during its first full-duplex transmission period FD1, receiving data from the second radio relay 102 (illustrated by the solid line arrow between the second radio relay 102 and the first radio relay 101 in FIG. 11 and by the reception RX_{F1} and emission TX′_{F1} periods hatched in FIG. 12); and
during its second full-duplex transmission period FD2, emitting data to the second radio relay 102 (illustrated by the dashed line arrow between the first radio relay 101 and the second radio relay 102 in FIG. 11 and by the emission TX_{F1} and reception RX′_{F1} periods hatched in FIG. 12).

Furthermore, the first radio relay 101 and a third radio relay 103 are within range of each other, and share the same time reference. The third radio relay 103 comprises an RF transceiver configured to allow transmissions according to an operating cycle C″ integrating, like the operating cycle C of the first radio relay 101, a first and a second full-duplex transmission period FD1″, FD2″ and a first and a second half-duplex transmission period HD1″, HD2″.

The first radio relay 101 and the third radio relay 103 are configured to operate, respectively, during the first and the second period FD1, FD2 and the first and the second period FD1″, FD2″ in a synchronous (or simultaneous) manner as illustrated in FIG. 13. The radio transmission modes M1“, M2”, M3″ relating to the operating cycle C″ of the third radio relay 103 are three frequencies F2, F6, F7. In particular, the first radio transmission mode M1″ of the third radio relay 103 is the same as the second radio transmission mode M2 of the first radio relay 101 (namely, frequency F2).

As shown in FIGS. 11 and 13, the first radio relay 101 is therefore capable of
during its first full-duplex transmission period FD1, emitting data to the third radio relay 103 (illustrated by the solid line arrow between the first radio relay 101 and the third radio relay 103 in FIG. 11 and by the emission TX_{F2} and reception RX″_{F2} periods hatched in FIG. 13); and
during its second full-duplex transmission period FD2, receiving data from the third radio relay 103 (illustrated by the dashed line arrow between the third radio relay 103 and the first radio relay 101 in FIG. 11 and by the reception RX_{F2} and emission TX″_{F2} periods hatched in FIG. 13).

Thus, in the presence of the second and the third radio relay 102, 103, the first radio relay 101 is, as shown in FIGS. 11 and 14, capable of
during its first full-duplex transmission period FD1, simultaneously receiving data from the second radio relay 102 and transmitting data to the third radio relay 103;
during its second full-duplex transmission period FD2, simultaneously receiving data from the third radio relay 103 and transmitting data to the second radio relay 102.

It follows, for the radio relays 101, 102, 103, that
by operating simultaneously during the first full-duplex transmission periods FD1, FD1′, FD1″, data can be relayed from the second radio relay 102 to the third radio relay 103;
by operating simultaneously during the second full-duplex transmission periods FD2, FD2′, FD2″, data can be relayed from the third radio relay 103 to the second radio relay 102;

In the presence of the second and the third radio relay 102, 103, the first radio relay 101 operates emitting and receiving (periods of the operating cycle C hatched in FIG. 14) during the first and the second full-duplex transmission periods FD1, FD2. The second radio relay 102 operates emitting during the first full-duplex transmission period FD1′ (its reception channel being, in this case, unused) and receiving during the second full-duplex transmission period FD2′ (its emission channel being, in this case, unused) (parts of the operating cycle C′ hatched in FIG. 12). The third radio relay 103 operates receiving during the first full-duplex transmission period FD1′ (its emission channel being, in this case, unused) and emitting during the second full-duplex transmission period FD2′ (its reception channel being, in this case, unused) (parts of the operating cycle C′ hatched in FIG. 13).

A fourth radio relay 104 comprises an RF transceiver configured to allow emissions-receptions according to an operating cycle C′″ having four periods HD2′″, FD1′″, HD1′″, FD2′″ arranged in time in this order: the first half-duplex transmission period HD2′″, the first full-duplex transmission period FD1′″, the second half-duplex transmission period HD1′″, and the second full-duplex transmission period FD2′″ (FIG. 15).

The first radio relay 101 and the fourth radio relay 104 share the same time reference. The first radio relay 101 and the fourth radio relay 104 are configured to operate, respectively, during the first half-duplex transmission period HD1 and the first full-duplex transmission period FD1′″ in a simultaneous (or synchronous) manner, as illustrated in FIG. 15. The first radio relay 101 and the fourth radio relay 104 are furthermore configured to operate, respectively, during the second half-duplex transmission period HD2 and the second full-duplex transmission period FD2′″ in a simultaneous (or synchronous) manner, as shown in FIG. 15. In other words, the fourth radio relay 104 is configured to alternately operate full-duplex and half-duplex with the first radio relay 101. In this case, the fourth radio relay 104 is configured to operate full-duplex (respectively, half-duplex) when the first radio relay 101 is configured to operate half-duplex (respectively, full-duplex). In general, the first radio 101 operates in half-duplex during the periods HD1 and HD2 while the fourth radio relay 104 operates full-duplex during the periods FD1′″ and FD2′″. In an embodiment, the fourth radio relay 104 does not operate during the first and the second half-duplex transmission periods HD2′″, HD1′″ of the operating cycle C′″, as illustrated in FIG. 15.

The radio transmission modes M1′″, M2′″, M3′″ relating to the operating cycle C′″ of the fourth radio relay 104 are three frequencies F8, F3, F9. In particular, the second radio transmission mode M2′″ of the fourth radio relay 104 is the same as the third radio transmission mode M3 of the first radio relay 101 (namely, frequency F3).

When the first radio relay 101 and the fourth radio relay 104 are within range of each other, the first radio relay 101 is, as shown in FIGS. 11 and 15, capable of
during its first half-duplex transmission period HD1, receiving data from the fourth radio relay 104 (illustrated by the dashed line arrow between the fourth radio relay 104 and the first radio relay 101 in FIG. 11 and by the reception RX_{F3} and emission TX″_{F3} periods hatched in FIG. 15); and
during its second half-duplex transmission period HD2, emitting data to the fourth radio relay 104 (illustrated by the dotted arrow between the first radio relay 101 and the fourth radio relay 104 in FIG. 11 and by the emission TX_{F3} and reception RX′″_{F3} periods hatched in FIG. 15).

In another embodiment illustrated by FIG. 16, the RF transceiver of the fourth radio relay 104 is configured to allow transmissions according to an operating cycle C″″ (similar to that of FIG. 5). Indeed, the first and the fourth radio relay 101, 104 are configured to operate in an alternating manner during the first and the second half-duplex transmission period. The fourth radio relay 104 is configured to emit during the second half-duplex transmission period HD2″″ (respectively, to receive during the first half-duplex transmission period HD1″″), when the first radio relay 101 is configured to receive during the first half-duplex transmission period HD1 (respectively, to emit during the second half-duplex transmission period HD2).

Generally, the first radio relay 101 is configured to
operate during the first half-duplex transmission period HD1 when the fourth radio relay 104 is configured to operate during the second half-duplex transmission period HD2″″; and
operate during the second half-duplex transmission period HD2 when the fourth radio relay 104 is configured to operate during the first half-duplex transmission period HD1″″.

The radio transmission modes M1″″, M2″″, M3″″ relating to the operating cycle C″″′ of the fourth radio relay 104 are three frequencies F8, F9, F3. In particular, the second radio transmission mode M3″″ of the fourth radio relay 104 is the same as the third radio transmission mode M3 of the first radio relay 101 (namely, frequency F3).

In this embodiment, when the first radio relay 101 and the fourth radio relay 104 are within range of each other, the first radio relay 101 is, such as shown in FIGS. 11 and 16, capable of
during its first half-duplex transmission period HD1, receiving data from the fourth radio relay 104 (illustrated by the dashed line arrow between the fourth radio relay 104 and the first radio relay 101 in FIG. 11 and by the reception RX_{F3} and emission TX″″_{F3} periods hatched in FIG. 16); and
during its second half-duplex transmission period HD2, emitting data to the fourth radio relay 104 (illustrated by the dotted arrow between the first radio relay 101 and the fourth radio relay 104 in FIG. 11 and by the emission TX_{F3} and reception RX″″_{F3} periods hatched in FIG. 16).

By considering the first and the second radio relays 101-102 or the first and the third radio relays 101-103, or the first, the second and the third radio relays 101, 102, 103 as being a radio relay line (or a radio relay linear network), the first and the second half-duplex transmission periods HD1, HD2 of the first radio relay 101 advantageously make it possible to bind (or join) the fourth radio relay 104 to this radio relay line. The first and the second half-duplex transmission periods HD1, HD2 of the first radio relay 101 make it possible to provide access to the linear network formed by the radio relays 101-103. This access is advantageously bidirectional (in the sense that data can be transmitted to and received from this radio relay line).

As described above, this binding or junction involves on the one hand the first and the second half-duplex transmission periods HD1, HD2 relating to the first radio relay 101 and on the other hand the first and second full-duplex transmission periods FD1′″, FD2′″ (embodiments illustrated in FIG. 15) or, alternatively, the second and the first half-duplex transmission periods HD2″″, HD1″″ (embodiments illustrated in FIG. 16) relating to the fourth radio relay 104.

Advantageously, the use of the first and the second full-duplex transmission periods FD1′″, FD2′″ for this junction (FIG. 15) allows the fourth radio relay 104 to be able to relay data (in particular, received from the first radio relay 101) during these same full-duplex transmission periods FD1′″, FD2′″ to another radio relay (not shown) to which this fourth radio relay 104 is connected like the first radio relay 101 connected to the second radio relay 102 or to the third radio relay 103.

The use of the first and the second half-duplex transmission periods HD1′″, HD2′″ for this junction (FIG. 16) allows the fourth radio relay 104 to be able to relay data (in particular, received from the first radio relay 101) during the full-duplex transmission periods FD1′″, FD2′″ to another radio relay (not shown) to which this fourth radio relay 104 is connected, like the second radio relay 102 connected to the first radio relay 101, or the third radio relay 103 connected to the first radio relay 101.

Referring to FIG. 17, radio relays 1a-1e are arranged in series or arranged in line so that any pair of successive radio relays of this radio relay 1a-1e plurality are within range of each other (a linear network). More generally, the radio relays 1a-1e are arranged to form a linear network or a line 22 of radio relays. This radio relay line 22 comprises a line-head radio relay 1a, a line-end radio relay 1e, and intermediate radio relays 1b-1d located between the line-head radio relay 1a and the line-end radio relay 1e. This radio relay line 22 also has a descending direction 23 going from the line-end radio relay 1e to the line-head radio relay 1a and an ascending direction 24 going from the line-head radio relay 1a to the line-end relay 1e.

To have a common notion of time within the radio relay line 22, the time reference 7 is the same for all of these radio relays 1a-1e. In an embodiment, this time reference 7 is based, as described above, on the PPS (Pulse Per Second) time and/or any other time information included in a global radiolocation signal, in particular the GPS. The radio relays 1a-1e of line 22 can thus operate simultaneously (in a synchronous manner) during full-duplex transmission periods, as described above for radio relay 101-103.

To avoid interference, different radio transmission modes are assigned to the radio relays 1a-1e which emit at the same time during the first and the second full-duplex transmission period FD1, FD2. To that end, various frequency multiplexing and/or antenna polarization and/or orthogonal code modulations and/or emission/reception direction techniques can be used so that radio relays 1a-1e within each other's range can emit simultaneously without risking interference. FIG. 17 illustrates the use of a set of different frequencies Fab, Fbc, Fcd, Fde. This frequency division multiplexing can, of course, be combined with other types of multiplexing (DSSS or FHSS type spectrum spreading, and/or vertical, horizontal or circular antenna polarization for example).

Two successive radio relays of the line 22 use the same radio transmission mode to communicate with each other in the ascending direction 24 and the descending direction 23. In the example of a frequency division multiplexing, two successive radio relays use a same frequency to emit towards each other (in the ascending and descending directions).

In an embodiment, an emission power in the ascending direction 24 and/or descending direction 23 are also assigned to each radio relay on line 22. The transmission power in the ascending direction and/or in the descending direction of a radio relay 1a-1e can, indeed, be adjusted according to the quality of the signal received by the radio relays on either side of this radio relay. This power can, in fact, be variable from one radio relay 1a-1e to another (two successive radio relays in non-direct visibility, a non-uniform inter-distance between the radio relays to cross, e.g., a water body located between two successive radio relays) so that the transmission power can be adjusted or self-regulated accordingly. For the same radio relay 1a-1e, the emission power in the ascending direction 24 can be different from that in the descending direction 23.

Given that a radio relay 1a-1e is configured to only communicate with the immediately adjacent radio relays on either side in line 22, a relatively low transmission power can advantageously be selected. This energy saving allows radio relays 1a-1e to operate longer without battery replacement and/or to operate with smaller capacity and/or smaller size batteries.

In addition, the transmission power of a radio relay 1a-1e of line 22 can be adapted so as to allow reusing at a further location in this line 22 a radio transmission mode used by this radio relay 1a-1e without risking interference. For example, a same frequency can be used several times in the same radio relay line 22. This advantageously makes it possible to use fewer radio transmission modes in total (which are in general limited) and/or to increase the number of radio relays 1a-1e in a line 22.

The radio relays 1a-1e are connected, directly or via gateways 18a, 18b, 18c to sensors 19d-19n. The head-end radio relay 1a is connected, via a bidirectional wired or wireless link, to a recording and command system 25.

As described above in particular for the radio relays 101-103, when the radio relays 1a-1e of line 22 operate simultaneously during the first and the second full-duplex transmission period,
data can be relayed/transferred, during the first full-duplex transmission period, from a radio relay 1a-1e to the radio relay 1a-1e downstream with respect to the descending direction 23 of the line 22 (solid line arrows between the radio relays 1a-1e in FIG. 17);
data can be relayed/transferred, during the second full-duplex transmission period, from a radio relay 1a-1e to a radio relay 1a-1e downstream with respect to the ascending direction 24 of the line 22 (dashed line arrows between the radio relays 1a-1e in FIG. 12).

As a result, advantageously, when the radio relays 1a-1e of line 22a operate simultaneously during the full-duplex transmission periods, data can be relayed or transferred by multi jumps (or multi-leaps) from any one of the radio relays 1a-1e to any one of the radio relays downstream with respect to the descending direction 23 (during the full-duplex transmission period) or ascending direction 24 (during the second full-duplex transmission period) of line 22.

Each of the radio relays 1a-1d is capable of transferring to the radio relay located downstream with respect to the ascending direction 24 of the line 22
data at its disposal (e.g., identifier, position data) or that it has generated (such as data confirming the integrity of data previously received from the preceding radio relay in the descending direction 23); or
data it has received from the radio relay located upstream with respect to the ascending direction 24 of line 22 (such as command data emitted by the recording and command system 25).

Each of the radio relays 1b-1e is capable of transferring to the radio relay located downstream with respect to the descending direction 23 of the line 22
data at its disposal (e.g., identifier, position data) or that it has generated (such as data confirming the integrity of data previously received from the preceding relay in the ascending direction 24); or
data it has received from the radio relay located upstream with respect to the descending direction 23 of line 22 (such as sensor data to be transferred to the recording and command system 25).

Therefore, by operating (i.e., emitting and receiving) during the first full-duplex transmission period, data from each of the sensors 19d-19n can be relayed to the recording and command system 25. By operating during the second full-duplex transmission period, administrative messages (commands from the recording and command system 25, acknowledgments, or synchronization frames, e.g.) can be relayed to reach any radio relay 1a-1e of line 22.

In an embodiment, a radio relay 1a-1e confirms, during the second full-duplex transmission period, the proper reception of data received during the first full-duplex transmission period by sending an acknowledgment or, alternatively, by sending an error message and/or a data retransmission request. This advantageously makes it possible to prevent data loss and to ensure that the data and/or instruction transmission is correctly terminated.

In another embodiment, a radio relay 1a-1e confirms, during the first full-duplex transmission period, the proper reception of data received during the second full-duplex transmission period of the previous operating cycle iteration.

In the case of internal synchronization within the radio relay line 22 based on sharing a reference clock, the data relayed in the ascending direction 24 may comprise synchronization frames. In the absence of a global radiolocation signal, a clock equipping the recording and command system 25 is, in an embodiment, used as a reference clock.

A second radio relay line 220 is also shown in FIG. 17, comprising a line-head 1x radio relay, and a line-end radio relay 1z. Like in the first line 22, data can be relayed in both directions within this second radio relay line 220 thanks to a set of radio transmission modes (frequencies Fxy, Fyz).

The second line 220 is, in one embodiment, mobile. The radio relays 1x-1z of the second line 22 are integrated in aerial vehicles 20x-20z (in particular, in drones). Sensors 19x-19z embedded in these aerial vehicles 20x-20z comprise, for example, an image sensor (in particular, a camera) or a position sensor (a GPS receiver).

The aerial vehicles 20x-20z move in a convoy (or in a pack) so as to keep substantially the same in-line spatial arrangement of the radio relays 20x-20z. Lateral, and/or longitudinal and/or vertical gaps between the aerial vehicles 20x-20z are, in an embodiment, maintained within predefined intervals when these aerial vehicles 20x-20z are in flight.

Radio relays 1x-1z are configured to operate during full-duplex transmission periods when radio relays 1a-1e are capable of operating during half-duplex transmission periods.

Following the example of the radio relays 101 and 104 described above, when the radio relay 1x and any radio relay 1d of the first line 22 are within range of each other, the second line 220 can be bound or branched onto the first line 22 through the radio relay 1x and the radio relay 1d which thereby becomes a junction relay. This trunk relay operates during its full-duplex transmission periods to relay data within the first line 22 and during its half-duplex transmission periods to provide the junction of the second line 220 to the first line 22.

To determine the third radio transmission mode to be used by the radio relay 1d during this junction, this radio relay 1d is, in one embodiment, configured to listen during its first half-duplex transmission period over a plurality of radio transmission modes including a predefined signal (in particular, a discovery signal) emitted according to this third radio transmission mode by the radio relay 1x during its first full-duplex transmission period (in the case of a junction according to the embodiments illustrated in FIG. 15) or its second half-duplex transmission period (in the case of a junction according to the embodiments illustrated in FIG. 16).

Alternatively, to determine the third radio transmission mode to be used by the radio relay 1x during this junction, the radio relay 1x is configured to listen during its first half-duplex transmission period (in the case of a junction according to the embodiments illustrated in FIG. 16) or during the second full-duplex transmission period (in the case of a junction according to the embodiments illustrated in FIG. 15), over a plurality of radio transmission modes including a predefined signal (in particular, a discovery signal) emitted according to the third radio transmission mode by a radio relay 1d during its second half-duplex transmission period.

In another embodiment, to determine the third radio transmission mode to be used by the radio relay 1d during this junction, this radio relay 1d is configured to emit signals (in particular, discovery signals) during its second half-duplex transmission period according to a plurality of radio transmission modes integrating the third radio transmission mode for the radio relay 1x configured to receive according to this third radio transmission mode during its second full-duplex transmission period (in the case of a junction according to the embodiments illustrated in FIG. 15) or its first half-duplex transmission period (in the case of a junction according to the embodiments illustrated in FIG. 16).

Alternatively, to determine the third radio transmission mode to be used by the radio relay 1x during this junction, this radio relay 1x is configured to emit during its first full-duplex transmission period (in the case of a junction according to the embodiments illustrated in FIG. 15) or during its second half-duplex transmission period (in the case of a junction according to the embodiments illustrated in FIG. 16) signals (in particular, discovery signals) according to a plurality radio transmission modes integrating the third radio transmission mode for the radio relay 1d configured to receive according to this third radio transmission mode during its first half-duplex transmission period.

Upon reception of a predefined discovery signal, the radio relay 1d (respectively, 1x) confirms to the radio relay 1x (respectively, 1d) the implementation of the junction according to the third radio transmission mode.

In an embodiment illustrated in FIG. 16, a third radio transmission mode is assigned to the radio relay 1x according to geolocation (virtual fencing or, in English, “geofencing”) comprising distinct (spatial or geographical) areas comprising (or, centred on), respectively, the positions of the radio relays 1a-1e. When the radio relay 1x is in an area comprising the position of the radio relay 1d, a third radio transmission mode M3 associated with this area is assigned to the radio relay 1x. Third radio transmission modes M3 of the radio relays 1a-1e can be associated with distinct areas comprising those radio relays 1a-1e. When the radio relay 1x is in one of these areas, the third radio transmission mode M3 associated with this area is assigned to the radio relay 1x. This advantageously makes it possible to avoid probing/searching for the discovery signals to be carried out by the radio relay 1x or by the radio relays 1a-1e.

In another embodiment shown in FIG. 15, the radio transmission mode used by the radio relay 1x to emit during the first full-duplex transmission period and to receive during the second full-duplex transmission period is assigned thereto according to geolocation (virtual fencing or, in English, “geofencing”) comprising distinct (spatial or geographical) areas comprising (or, centred on), respectively, the positions of the radio relays 1e-1e. When the radio relay 1x is in an area comprising the position of the radio relay 1d, a radio transmission mode associated with that area is assigned to the radio relay 1x to emit during its first full-duplex transmission period and receive during its second full-duplex transmission period. These radio transmission modes assigned to the radio relay 1x can be associated with distinct areas comprising the radio relays 1a-1e. When the radio relay 1x is in one of these areas, the radio transmission mode associated with this area is assigned to the radio relay 1x. This advantageously makes it possible to avoid probing/searching for the discovery signals to be carried out by the radio relay 1x or by the radio relays 1a-1e.

To switch from one junction radio relay to another one on line 22, a mechanism for transferring the junction (“handover”) can be implemented.

In an embodiment, when the radio relays 1x-1z operate full-duplex at the time the radio relays 1a-1e are able to operate half-duplex (embodiments illustrated in FIG. 15), the second line 220 can be bound to the first line 22 without the radio relays 1x-1z having to operate during their half-duplex transmission periods. None of the radio relays 1x-1z operates during its first or second half-duplex transmission period.

In another embodiment, when the radio relays 1x-1z and the radio relays 1a-1e operate simultaneously during their half-duplex transmission periods like the embodiments illustrated in FIG. 16 (i.e., when the junction between the first and the second line 22, 220 involves half-duplex transmission periods), an intermediate radio relay 1y of the second line 220 (in particular, located in the middle of the second line 220) can also be used instead of the line-head radio relay 1x to bind this second line 220 to a junction radio relay 1d of the first line 22. The routing of data within the second line 220 to the line-head radio relay 1x requires an increasingly large transfer capacity when approaching the line-head radio relay 1x. The use of an intermediate radio relay 1y to link the second line 220 to the first line 22 makes it possible to alleviate the constraint in terms of data transfer capacity of the radio relays 1x-1z.

Advantageously, the first line 22 forms an access network for the second line 220. Consequently, command data from the recording and command system 25 can be intended for the control unit 21x-21z for controlling one or several of the aerial vehicles 20x-20z (navigation commands, e.g.), and/or to one or several sensors 19x-19z included in these aerial vehicles 20x-20z (commanding a camera, e.g.). In the opposite direction, video data provided by embedded cameras can be relayed to the recording and command system 25.

When an operating cycle of the radio relays 1a-1e extends over six periods as illustrated in FIG. 6, a third radio relay line (not shown) can, like the second line 220, be connected to the first line 22 at the junction radio relay 1d or at another radio relay of the first line 22. A junction radio relay can be any one of the radio relays 1a-1e of the first line 22, namely a line-head radio relay 1a, a line-end radio relay 1e, or an intermediate radio relay 1b-1d.

In an implementation illustrative of the various embodiments described above, a plurality of radio relays 41-49 are used to form an embedded internal telecommunication system for carrying out a seismic measurement campaign.

Referring to FIG. 18, the purpose of this seismic measurement campaign is to image the underground geological structure of an area of interest 26 in order to prospect for natural resources therein (such as hydrocarbons or underground water). This area of interest 26 is generally several hundred square meters wide, or even square kilometers wide.

To that end, a plurality of gateways 181-189 are arranged/distributed so as to optimally cover the area of interest 26. Each of the gateways 181-189 is provided with a radio relay 41-49. The radio relays 41-49 are grouped into radio relay land lines 51-53, each land line 51-53 having a line-head radio relay and a line-end radio relay. During a configuration step, a set of radio transmission modes is assigned to the radio relays 41-49. The transmission powers can be automatically adapted according to the propagation conditions in the area of interest 26 and to the arrangement of the adjacent radio relays for each radio relay 41-49 (following a step of probing/discovery of the neighboring radio relays). The land lines 51-53 can be formed manually or automatically basing, for example, on the geographical positions of the radio relays 41-49.

Each of the head-end radio relays 41, 44, 47 is connected via a wired or wireless link to the recording and command system 250. An identifier can be assigned to each land line 51-53 or, in an equivalent manner, to each head-end radio relay 41, 44, 47.

A plurality of seismic sensors 19 (geophones or probes) are intended to be disposed on the surface of the area of interest 26 according to a predefined grid linked to the desired seismic imaging resolution. These seismic sensors 19 are intended to record echoes of seismic waves (a seismic signature) of the underground geological structure of the area of interest 26 in response to seismic waves generated by a vibration source 27 (e.g., an explosive material, the fall of a weight, or a mechanical device being a vibrating energy source). To that end, one or more aerial vehicles 61-62, each being provided with a radio relay, form a radio relay aerial line 221. At least one of the aerial vehicles 61-62 carries a seismic sensor. The aerial vehicles 61-62 are, in an embodiment, directed, according to location information provided thereto by the recording and command system 250, towards the coverage area of a gateway 182 to drop thereto (to release with or without initial speed) a seismic sensor at a specific location. The seismic sensor is made in such a way as to facilitate its sinking into the ground.

The aerial vehicles 61-62 move in convoy (or as a block) to keep a same spatial arrangement or substantially constant inter-distances. Alternatively, the aerial line 221 is automatically and dynamically formed based on, for example, position data from the aerial vehicles 61-62.

As soon as an aerial vehicle 61-62 is within range of the radio relay 42, a junction is created between the aerial line 221 and the land line 51. The recording and command system 250 can thus communicate with the aerial vehicles 61-62 via the radio relay land line 51. Consequently, image data acquired by an image sensor (such as a camera) integrated into any one of the aerial vehicles 61-62 are sent to the junction radio relay 42 which is in charge of relaying them in the descending direction of line 51 to the registration and command system 250. In the reverse direction (i.e., in the ascending direction of line 51), commands may be transmitted from the recording and command system 250 to the aerial vehicles 61-62.

More generally, the aerial radio relay line 221 accesses the land radio relay network through a junction radio relay 42 and via which can communicate with the registration and command system 250. Data transmitted by the radio relay embedded in an aerial vehicle 61-62 may include data relating to that aerial vehicle (including, but not limited to, battery charge level, operating status of the embedded electronics, its heading, position data), an identifier of the junction radio relay 42, an acknowledgment, or any data provided by a sensor integrated into this aerial vehicle 61-62 (image sensor, microphone, position sensor, e.g.).

In an embodiment, video data provided by cameras embedded in the aerial vehicles 61-62 is transferred via land line 51. As for the control and command messages for the aerial vehicles 61-62, they can be sent via the land line 51 (in the ascending direction) or via another dedicated telecommunication network.

The command data emitted from the recording and command system 250 may comprise command data of the aerial vehicle 61-62 (adapting its height to take into account an irregularity in the field so that the seismic sensor sinks appropriately at an acceptable depth into the ground, the ground limits of a region in which the seismic sensor can be dropped, or the orientation of a camera, for example).

An aerial line 221 composed of more than one aerial vehicle 61-62 advantageously makes it possible to provide the recording and command system 250 with additional information (in particular, additional views) in order to choose the dropping location of a seismic sensor. This additional information makes it possible to better analyze the dropping location and determine the optimal location for the seismic sensor (in particular, in a dense forest where several views are sometimes required).

Once the area of interest 26 is delimited on the surface by the spatial extension of the seismic sensor 19 network, a seismic vibration is generated on the surface by the vibration source 27 and the echoes thereof are simultaneously measured by the seismic sensor 19 network deployed on the surface. Then, each of the seismic sensors 19 communicates its measurement data to the gateway 181-189 to which it is connected. In turn, each gateway 181-189 transfers the received measurement data to the corresponding radio relay 41-49. In an embodiment, the gateway 181-189 retrieves via a wireless link the seismic data measured by the seismic sensors 19 within its range and transfers them to the radio relay 41-49. More generally, the seismic data measured by a seismic sensor 19 are, directly or indirectly, communicated to a radio relay 41-49 associated therewith.

The measurement data at disposal of the radio relays 41-49 is relayed, as described above, along each landline 51-53 to the recording and command system 250. A radio relay 41-49 transfers the measurement data received via its digital interface 8 as well as those received via its reception channel RX. An increasingly high data transfer rate is therefore required when approaching the head-end radio relay.

In an advantageous embodiment, instead of transferring the measurement data, a radio relay 41-49 stores in its memory 9 the data received via its digital interface 8 and transfers quality data relating to this measurement data. In other words, the seismic data is at least partially stored locally in the radio relay 41-49. This advantageously makes it possible to reduce the size of the data to be relayed as well as to provide, almost real-time, information concerning a recording which has just been performed before moving on to a new recording.

The data stored in the radio relay 41-49 can be retrieved in delayed time, for example during a planned movement of the radio relays 41-49. In an embodiment, the data stored in a radio relay 41-49 are at least partially communicated to a radio relay aerial line 221, 222 bound to the land line 51-53 integrating this radio relay 41-49.

A radio relay aerial line 222 can also be used for monitoring the area of interest 26. Under control of the recording and command system 250, an aerial vehicle 63 leaves a station located in or around the area of interest 26, flies over the area of interest 26 and transmits, for example, video data in particular of a target area via land lines 51-53 to which the radio relay integrated into this aerial vehicle 63 is successively bound. The data sent to this aerial vehicle 63 via a radio relay land line 51-53 may comprise information concerning a route, or a flight pattern (manual control, automatic flight, or autonomous flight).

Furthermore, when the RF transceivers of the radio relays of a land line 52 are of the narrow-band type or when these radio relays comprise secondary RF transceivers of the narrow-band type, command messages for aerial vehicles 61-63 and/or the communications of a field team member 28 can be conveyed via this radio relay land line 52. In another embodiment, a secondary RF transceiver, external to the radio relay 41-49, is connected to a second digital interface of the radio relay. In this case, data from the secondary RF transceiver is transferred to the radio relay 41-49 which is in charge of transferring them (connecting one field team member to another, or to the recording and command system 250).

This advantageously results in the radio relays 41-49 used making it possible to collect the seismic measurement data and at the same time to communicate with one or several aerial vehicles 61-63, as well as to support a communication network between the team members in the field. More generally, a radio relay line 51-53 is able to convey the data of any system linked therewith.

Advantageously, the radio relay land lines 51-53 form a single access network for collecting seismic data, the communication with the aerial vehicles 61-63, and possibly also with the operators in the field. Instead of using a dedicated telecommunications network to communicate with the recording and command system 250, an aerial vehicle 61-63 provided with a radio relay uses the radio relays 41-49 as an access point. Based on the radio relay land lines 51-53, the aerial vehicle 61-63 can be fully controlled to fly it to a precise position over the full extent of the area of interest 26, as well as to remotely command the embedded sensors therein.

It is important to note that seismic imagery is given here only as an example, a measurement campaign that may have as an object the observation of any other physical quantity other than seismic echoes.

The embodiments described above have a certain number of advantages.

They indeed allow
to reduce the cost of measurement campaigns, in particular in environments that are difficult to access to, and without infrastructure networks;
to extend the range of communications with the aerial vehicles and/or with operators in the field over the entire extent of the prospecting area;
to systematically couple the range of aerial vehicles to the prospecting area covered by the radio relay lines. This gives flexibility in the choice of the shape and extent of the prospecting area;
to be able to command aerial vehicles up to remote locations in the prospecting area;
to combine all the networks (the networks of the aerial vehicles, that of the operators, and that of measurement data collection) into a single network unifying radio relays so as to remedy the increase in the number and heterogeneity of telecommunications networks used during measurement campaigns;
rapid deployment of measurement campaigns.

1. A radio relay comprising a radiofrequency transceiver integrating a reception channel and an emission channel this radiofrequency transceiver being configured to allow transmissions according to an operating cycle comprising:
a first full-duplex transmission period during which the reception channel and the emission channel are configured to allow, respectively, a reception according to a first radio transmission mode and an emission according to a second radio transmission mode different from the first radio transmission mode;
a first half-duplex transmission period during which the reception channel is configured to allow a reception according to at least a third radio transmission mode;
a second full-duplex transmission period during which the reception channel and the emission channel are configured to allow, respectively, a reception according to the second radio transmission mode and an emission according to the first radio transmission mode;
a second half-duplex transmission period during which the emission channel is configured to allow an emission according to at least the third radio transmission mode.

2. The radio relay according to claim 1, characterized in that it further comprises an antenna device, this antenna device having a radiation pattern including:
a first lobe in a first emission/reception direction;
a second lobe in a second emission/reception direction;
a third lobe in a third emission/reception direction the second and the third emission/reception direction being substantially included in a plane the first emission/reception direction being substantially perpendicular to said plane.

3. The radio relay according to claim 2, characterized in that the radio frequency transceiver is configured to allow, during the first half-duplex transmission period, a reception in the first emission/reception direction the RF transceiver being further configured to allow, during the second half-duplex transmission period, an emission in the first emission/reception direction.

4. The radio relay according to claim 2, characterized in that the radio frequency transceiver is configured to allow emission in the first emission/reception direction during the first full-duplex transmission period, and reception in the first emission/reception direction during the second full-duplex transmission period.

5. The radio relay according to claim 2, characterized in that the radiofrequency transceiver is configured to allow:
during the first full-duplex transmission period, an emission in the first emission/reception direction and a reception in the second emission/reception direction;
during the second full-duplex transmission period, a reception in the first emission/reception direction and an emission in the second emission/reception direction.

6. The radio relay according to claim 1, characterized in that the third radio transmission mode is the first radio transmission mode.

7. The radio relay according to claim 1, characterized in that the second radio transmission mode or the third radio transmission mode is associated with a predefined area, this second radio transmission mode or this third radio transmission mode being assigned to the radio relay when this radio relay is located in said predefined area.

8. radio relay according to claim 1, characterized in that the first radio transmission mode and the second radio transmission mode use, respectively,
a first frequency and a second frequency different from the first frequency, and/or
a first modulation and a second modulation based on orthogonal codes; and/or
a first antenna polarization and a second antenna polarization different from the first antenna polarization; and/or
a first emission/reception direction and a second emission/reception direction different from the first emission/reception direction.

9. A data transfer system including:
a first radio relay according to claim 2 wherein the radio frequency transceiver is configured to allow, during the first half-duplex transmission period, a reception in the first emission/reception direction, the RF transceiver being further configured to allow, during the second half-duplex transmission period, an emission in the first emission/reception direction, and a second radio relay according to claim 2 wherein the radio frequency transceiver is configured to allow emission in the first emission/reception direction during the first full-duplex transmission period, and reception in the first emission/reception direction during the second full-duplex transmission period, the first radio relay and the second radio relay being configured to operate, respectively, during the first half-duplex transmission period and the first full-duplex transmission period in a simultaneous manner, the first radio relay and the second radio relay being further configured to operate, respectively, during the second half-duplex transmission period and the second full-duplex transmission period in a simultaneous manner, or
a first radio relay according to claim 2 wherein the radio frequency transceiver is configured to allow, during the first half-duplex transmission period, a reception in the first emission/reception direction, the RF transceiver being further configured to allow, during the second half-duplex transmission period, an emission in the first emission/reception direction and a second radio relay according to claim, wherein the radio frequency transceiver is configured to allow, during the first half-duplex transmission period, a reception in the first emission/reception direction, the RF transceiver being further configured to allow, during the second half-duplex transmission period, an emission in the first emission/reception direction, the first radio relay being configured to operate during the first half-duplex transmission period when the second radio relay is configured to operate during the second half-duplex transmission period, the first radio relay being further configured to operate during the second half-duplex transmission period when the second radio relay is configured to operate during the first half-duplex transmission period.

10. A system according to claim 9, characterized in that it further comprises an aerial vehicle, wherein this aerial vehicle is provided with the second radio relay.

11. The radio relay according to claim 2, characterized in that the third radio transmission mode is the first radio transmission mode

12. The radio relay according to claim 3, characterized in that the third radio transmission mode is the first radio transmission mode

13. The radio relay according to claim 4, characterized in that the third radio transmission mode is the first radio transmission mode

14. The radio relay according to claim 5, characterized in that the third radio transmission mode is the first radio transmission mode

15. The radio relay according to claim 2, characterized in that the second radio transmission mode or the third radio transmission mode is associated with a predefined area, this second radio transmission mode or this third radio transmission mode being assigned to the radio relay when this radio relay is located in said predefined area.

16. The radio relay according to claim 3, characterized in that the second radio transmission mode or the third radio transmission mode is associated with a predefined area, this second radio transmission mode or this third radio transmission mode being assigned to the radio relay when this radio relay is located in said predefined area.

17. The radio relay according to claim 4, characterized in that the second radio transmission mode or the third radio transmission mode is associated with a predefined area, this second radio transmission mode or this third radio transmission mode being assigned to the radio relay when this radio relay is located in said predefined area.

18. The radio relay according to claim 5, characterized in that the second radio transmission mode or the third radio transmission mode is associated with a predefined area, this second radio transmission mode or this third radio transmission mode being assigned to the radio relay when this radio relay is located in said predefined area.

19. The radio relay according to claim 2, characterized in that the first radio transmission mode and the second radio transmission mode use, respectively,
a first frequency and a second frequency different from the first frequency, and/or
a first modulation and a second modulation based on orthogonal codes; and/or
a first antenna polarization and a second antenna polarization different from the first antenna polarization; and/or
a first emission/reception direction and a second emission/reception direction different from the first emission/reception direction.

20. The radio relay according to claim 3, characterized in that the first radio transmission mode and the second radio transmission mode use, respectively,
a first frequency and a second frequency different from the first frequency, and/or
a first modulation and a second modulation based on orthogonal codes; and/or
a first antenna polarization and a second antenna polarization different from the first antenna polarization; and/or
a first emission/reception direction and a second emission/reception direction different from the first emission/reception direction.
